(19) United States
(12) Patent Application Publication
(10) Pub. No.: US 2025/0392928 A1
(43) Pub. Date: Dec. 25, 2025

(54) RESTORING WIRELESS NETWORK CONNECTIVITY

(71) Applicant: Hewlett-Packard Development Company, L.P., Spring, TX (US)

(72) Inventors: Xin-Chang Chen, Taipei City (TW); Chia-Hung Kuo, Taipei City (TW); Chung-Chun Chen, Taipei City (TW); He-Di Liu, Taipei City (TW); Shih-Yen Cheng, Taipei City (TW)

(73) Assignee: Hewlett-Packard Development Company, L.P., Spring, TX (US)

(21) Appl. No.: 18/878,517

(22) PCT Filed: Jun. 24, 2022
(86) PCT No.: PCT/US2022/034880

§ 371 Date: Dec. 23, 2024

(51) Int. Cl. H04W 24/04; H04L 41/0663; H04W 8/24

(52) U.S. Cl. CPC H04W 24/04; H04L 41/0663; H04W 8/245

(57) ABSTRACT

A first component of a computing device detects that first component wireless network connectivity has failed. A second component of the computing device, using second component wireless network connectivity, subsequently retrieves and stores updated first component wireless network connectivity information. The first component then restores the first component wireless network connectivity. Either the first component is an operating system and the second component is firmware, or the first component is the firmware and the second component is the operating system.

### BACKGROUND

Computing devices can include computers, such as desktop, laptop, notebook, and convertible computers, as well as other types of computing devices, including smartphones, tablet computing devices, and so on. Computing devices are commonly connected to networks, including the Internet. For example, computing devices can be connected to a wireless local area network (WLAN) using Wi-Fi® technologies.

### BRIEF DESCRIPTION OF THE DRAWINGS

FIG. 1 is a diagram of an example computing device having wireless network connectivity.

FIGS. 2A, 2B, and 2C are diagrams of example processes for restoring operating system wireless network connectivity via firmware wireless network connectivity.

FIG. 3 is a diagram of a non-transitory computer-readable data storage medium storing program code for restoring operating system wireless network connectivity via firmware wireless network connectivity.

FIGS. 4A and 4B are diagrams of example processes for restoring firmware wireless network connectivity via operating system wireless network connectivity.

FIG. 5 is a flowchart of an example method for restoring firmware wireless network connectivity via operating system wireless network connectivity.

FIG. 6 is a flowchart of an example method for restoring firmware system wireless network connectivity via operating system wireless network connectivity, and vice-versa.

### DETAILED DESCRIPTION

As noted in the background, computing devices such as computers, often connect to networks like the Internet in a wireless manner. Such wireless network connectivity can be more convenient than wired network connectivity. For instance, whereas wired network connectivity may require that there be wired network infrastructure at the location where a computing device is being used to connect via one or multiple cables to a network, wireless network connectivity does not.

Wireless network connectivity can include a wireless network hardware driver and associated wireless network settings that enable a computing device to wirelessly connect to a network, such as a wireless local area network (WLAN), by using Wi-Fi® or other wireless technologies. A driver is program code or a computer program that is installed so that a corresponding peripheral device is accessible by other software. A wireless network hardware driver is thus the driver for the wireless network hardware of a computing device that is used to communicate wirelessly with a network.

The wireless network settings can include information for configuring the wireless network hardware driver to connect to a particular wireless network. For example, in the case of a WLAN, the wireless network settings can include the name of the network in the form of a service set identifier (SSID), the type of network security being used (if any), and the password for network if security is being used. The wireless network settings can include whether the computing device is to dynamically obtain a network address, such as an Internet protocol (IP) address, and associated information such as a subnet mask, a router, base station, or access point network address, and/or a domain name server (DNS) network address. If the computing device is not to dynamically obtain this information, the wireless network settings can include a static network address and the associated information.

A computing device such as a desktop, laptop, notebook, or convertible computer can include firmware, in the form of an embedded controller, basic input/output system (BIOS), and/or a unified extensible firmware interface (UEFI). When the computing device, the firmware initially runs before loading or booting an operating system that is executed by a processor of the computing device, such as a central processing unit (CPU). Once the operating system has been loaded, application programs and other software can run on, at, or in conjunction with the operating system.

Both the firmware and the operating system can have their own wireless network connectivity (e.g., a wireless network hardware driver and/or wireless network settings) that are independent of one another even though both pertain to the same underlying wireless network hardware of the computing device. That is, the firmware may have firmware network wireless network connectivity, and the operating system may have operating system wireless network connectivity. The firmware wireless network connectivity and the operating system wireless network connectivity are separate and independent of one another.

Wireless network connectivity can fail. For example, in the case of the operating system, a portion of the operating system may be updated without the wireless network hardware driver of the operating system being updated. The wireless network hardware driver of the operating system may become corrupted. The wireless network settings for the wireless network hardware driver of the operating system may become out of date, may become corrupted, or may accidentally be erased. In such instance, application programs running in conjunction with the operating system are no longer able to access the wireless network, even though the underlying wireless network hardware may itself not have failed.

Techniques described herein ameliorate this and other issues. When the operating system wireless network connectivity has failed, a corresponding firmware flag may be set and the computing device restart. At restart, the firmware detects that the flag has been set, and in response retrieves and stores updated operating system wireless network connectivity information using its own firmware wireless network connectivity, which may not have failed. When the operating system is then booted or loaded, the operating system can update its operating system wireless network connectivity using the updated information retrieved by the firmware. The updated information can include an updated wireless network driver and/or updated wireless network settings, for example.

The techniques described herein therefore leverage the fact that the firmware and operating system have their own wireless network connectivity to restore the operating system wireless network connectivity when it has failed, by using the firmware wireless network connectivity to download updated information. The techniques can also be used in reverse. That is, upon failure, the firmware wireless network connectivity can be restored by using the operating system wireless network connectivity to download updated firmware wireless network connectivity information.

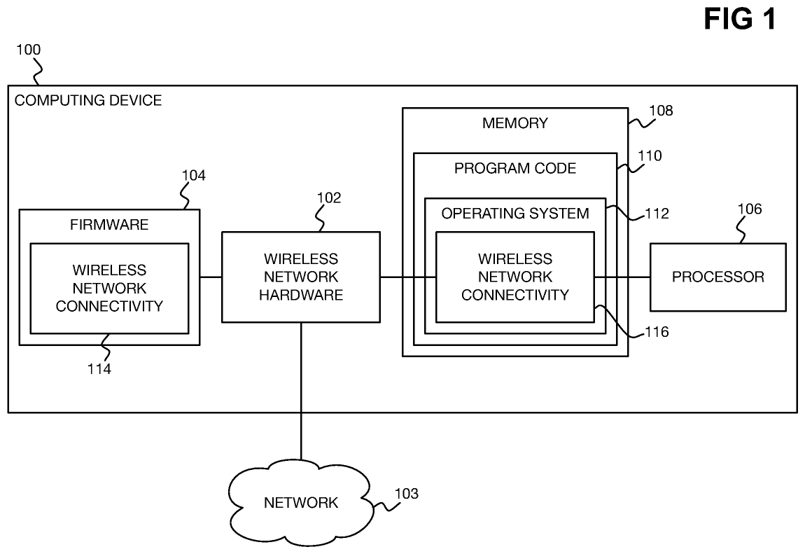

FIG. 1 shows an example computing device 100. The computing device 100 may be a desktop, laptop, notebook, convertible, or other type of computer, or another type of computing device, such as a smartphone or tablet computing device, among other types of computing devices. The computing device 100 can include components other than those shown. The computing device 100 as depicted includes wireless network hardware 102, firmware 104, a processor 106, and memory 108.

The wireless network hardware 102 is the hardware that performs wireless communication to connect to, transmit data to, and receive data from a network 103. The wireless network hardware 102 may be or include one or multiple antennas, as well as one or multiple integrated circuits (ICs), such as application-specific ICs (ASICs), which are on a primary logic board of the computing device 100 or a separate logic board. The wireless network hardware 102 may be a wireless network adapter, for instance, which employs Wi-Fi® technologies over the 2.4 gigahertz (GHz), 5 GHz, or other frequency bands. The network 103 may be or include a WLAN permitting connection to other networks, including the Internet.

The firmware 104 may be or include an embedded controller, BIOS, and/or UEFI. The embedded controller may be an IC, such as an ASIC, that executes the BIOS and/or UEFI, which may be stored in non-volatile memory, such as flash memory, read-only memory (ROM), programmable ROM (ROM), static random-access memory (SRAM), and so on. When the computing device 100 is started or restarted, the firmware 104 is executed (i.e., the embedded controller executes the BIOS and/or the UEFI) before booting or loading the operating system 112.

The BIOS is low-level software that is responsible for starting hardware components of the computing device 100, and ensuring the components are working properly before running a bootloader that boots the operating system 112. The BIOS may perform a power-on self test (POST), for instance, to ensure that the current hardware configuration of the computing device 100 is valid and working properly. Once POST has finished, the BIOS looks for a master boot record (MBR) stored on a boot storage device and uses it to launch the bootloader that loads the operating system 112.

The UEFI can supplant or supplement the BIOS. The UEFI can supplant the BIOS in that it can be used instead of the BIOS. The UEFI can supplement the BIOS in that it can emulate the BIOS. Like the BIOS, the UEFI is low-level software responsible for starting and ensuring the hardware components of the computing device are working properly before loading or booting the operating system 112. The UEFI includes more features than the BIOS, such as booting from larger storage devices, using GUID partition table (GPT) partitioning instead of an MBR, performing secure boot to ensure that the operating system 112 has not been tampered, and so on. The UEFI can also be loaded from a hard disk drive or other storage device, including that from which the operating system 112 is loaded into the memory 108, from a network share, and so on.

Once the firmware 104 has completed its initial functionality at start or restart of the computing device 100, the firmware 104 loads the program code 110 for the operating system 112 into memory 108, and passes control to the processor 106 to execute the program code 110. The program code 110 may be loaded into the memory 108 from a non-volatile storage device, such as a hard disk drive or solid state drive (SSD). By comparison, the memory 108 may be volatile random-access memory (RAM), such as dynamic RAM (DRAM). The entirety of the program code 110 for the operating system 112 may not be loaded into the memory 108 at all times, but rather the program code 110 may be switched into and out of the memory 108 as needed.

Execution of the program code 110 by the processor 106 therefore provides for running of the operating system 112. Examples of the operating system 112 include versions of the Microsoft Windows® operating system, available from Microsoft Corp., of Redmond, Wash., as well as versions of the LINUX® operating system. Once the operating system 112 has loaded, other software, including application programs, background services, and so on, may be loaded and run on, in, or in conjunction with the operating system 112. An application program can be a computer program that interacts with a user of the computing device 100 and/or that has its execution initiated by the user for performing intended functionality, for instance. A background service can be a computer program that runs in the background, and with which the user may not interact.

Both the firmware 104 and the operating system 112 have respective wireless network connectivity 114 and 116. The wireless network connectivity 114 of the firmware 104 is referred to as firmware wireless network connectivity, whereas the wireless network connectivity 116 of the operating system 112 is referred to as operating system wireless network connectivity. The wireless network connectivity 114 and 116 are independent and separate of one another, and permit the firmware 104 and the operating system 112 to respectively use the wireless network hardware 102 to wirelessly communicate over or with the network 103.

The firmware wireless network connectivity 114 may include program code that is part of the BIOS or UEFI, and that is executed by the embedded controller to access the network via the wireless network hardware 102. The firmware wireless network connectivity 114 may include wireless network settings as have been described, as well as those that specifically provide for the firmware 104 to connect to a particular server device, such as a particular cloud server or network host, on the Internet that is accessible through the network 103 via the wireless network hardware 102. The firmware 104 thus can access the network 103 using the wireless network hardware 102 without having to use the wireless network connectivity 116 of the operating system 112.

The operating system wireless network connectivity 116 may include a wireless network hardware driver for the wireless network hardware 102 and is installed within the operating system 112. When application programs, background services, and other software running in, on, or in conjunction with the operating system 112 have to access the network 103, they access corresponding application programming interfaces (APIs) of the operating system 112 to effectively use the wireless network hardware driver and thus the wireless network hardware 102 for such wireless communication. At the level of the operating system 112, therefore, the network 103 is accessed using the wireless network hardware 102 without having to use the wireless network connectivity 114 of the firmware 104.

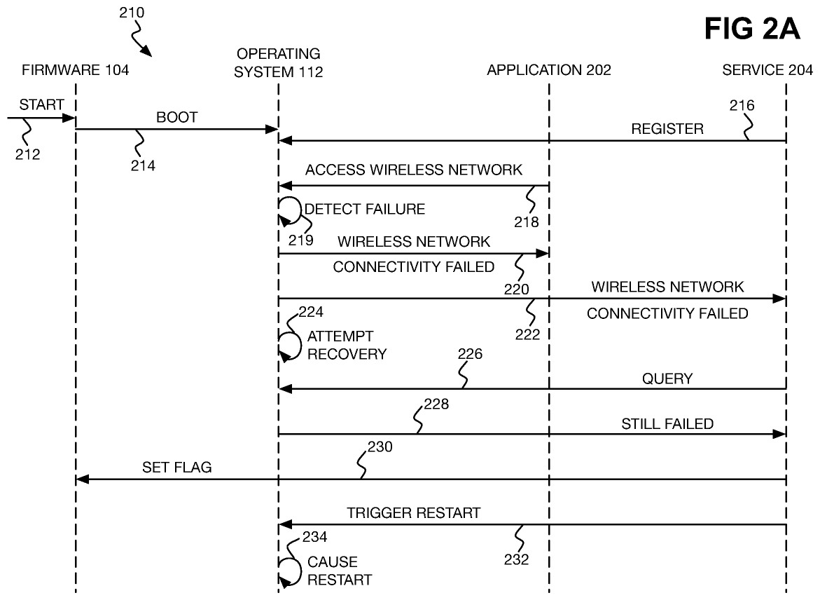

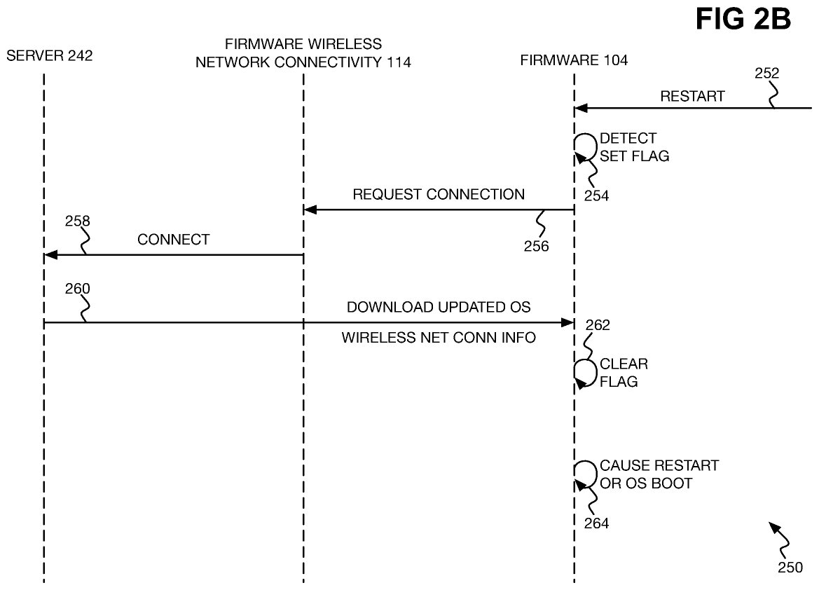

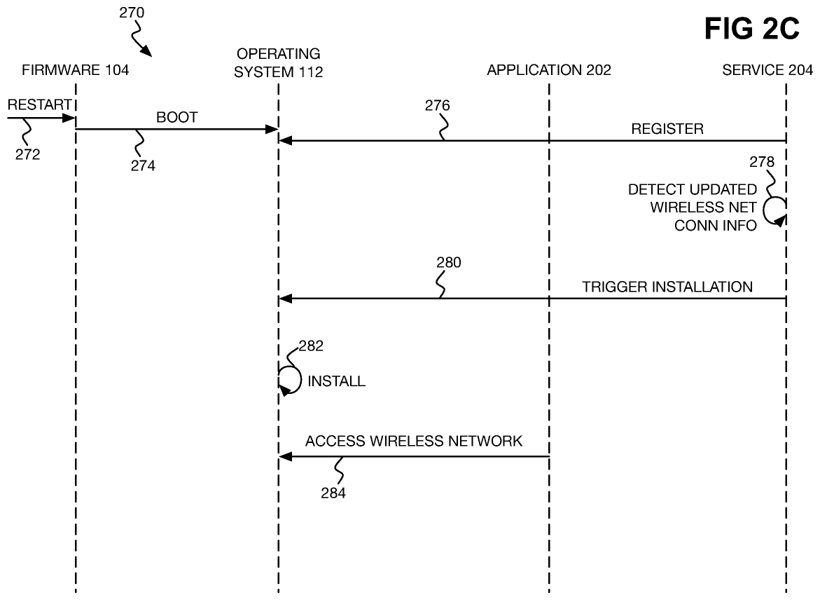

FIGS. 2A, 2B, and 2C show respective processes 210, 250, and 270 for restoring the operating system wireless network connectivity 116 upon failure by leveraging the firmware wireless network connectivity 114 that has not failed. The firmware 104 and the operating system 112 are depicted, as well as an application 202 and a service 204. The firmware 104 may include the BIOS or UEFI, as executed by the embedded controller. The application 202 can be an application program that runs in, on, or in conjunction with the operating system 112 to access the network 103 using the operating system wireless network connectivity 116. As one example, the application 202 may be a web browsing computer program. The service 204 can be a background service that runs when the operating system 112 is running.

In the process 210 of FIG. 2A, at start (including restart) (212) of the computing device 100, the firmware 104 is initially loaded and loads or boots (214) the operating system 112, causing the operating system 112 to run. As part of startup of the operating system 112, the service 204 registers (216) with the operating system 112 to receive status change events regarding the ability of the wireless network connectivity 116 to connect to and communicate with the network 103 using the wireless network hardware 102. The application 202 may then attempt to access (218) and communicate over the network 103 by making corresponding API calls to the operating system 112, which cause the wireless network connectivity 116 to attempt access of and communication over the network 103 via the wireless network hardware 102.

However, the operating system 112 detects (219) that the wireless network connectivity 116 has failed, in that the wireless network connectivity 116 is unable to use the wireless network hardware 102 to connect to, access, and/or communicate over the network 103. For instance, the wireless network hardware driver may notify that the operating system 112 that it is unable to connect to the network 103 using the wireless network hardware 102, and therefore unable to communicate over the network 103. The operating system 112 notifies (220) the application 202 that the wireless network connectivity 116 has failed. As a result of prior registration of the service 204 with the operating system 112, the service 204 is also notified (222) of the failure of the wireless network connectivity 116, since such failure triggers a status change event.

The operating system 112 may or may not attempt recovery (224) of the wireless network connectivity 116. As one example, the operating system 112 may guide the user through step-by-step troubleshooting instructions in an attempt to resolve the underlying problem causing the failure. The user may be asked to reboot the wireless network router or access point that is to establish the network 103 with which the wireless network connectivity 116 is to connect, for instance. The user may be asked to verify the password used to connect to the network 103, and/or be presented with a list of names of other networks 103 that are within range of the wireless network hardware 102. The service 204 may subsequently query (226) the operating system 112 to determine whether recovery is successful, and if unsuccessful, the operating system 112 in response notifies (228) the service 204 that the wireless network connectivity 116 is still in a state of failure.

The service 204 then sets (230) a firmware flag in the firmware 104 indicating that the operating system wireless network connectivity 116 has failed. The firmware flag may be set in a register of the BIOS or UEFI that is non-volatile and which survives restarts of the computing device 100. Upon setting the firmware flag, the service 204 triggers restart (232) of the computing device 100 with the operating system 112. The operating system 112 responsively causes (234) the computing device 100 to restart. The user may first be notified and his or her approval requested before the operating system 112 causes such restart, and the user may also be notified that restoration of the operating system wireless network connectivity 116 will be attempted upon restart of the computing device 100.

Next, in the process 250 of FIG. 2B, at restart (252) of the computing device 100 as caused by the operating system 112 in the process 210, the firmware 104 is initially loaded as before. However, the firmware 104 detects (254) that the flag has been set which indicates that the operating system wireless network connectivity 116 has failed. For example, the embedded controller when executing the BIOS or the UEFI may detect that the flag has been set in its corresponding register. As a result, the firmware 104 does not proceed to loading or booting of the operating system 112.

Rather, the firmware 104, in response to detecting setting of the flag, requests (256) via the firmware wireless network connectivity 114, connection (258) to a server 242 accessible over the network 103. The server 242 may be a cloud server maintained by or for the manufacturer of the computing device 100, for instance. The identification of the server 242 is specified within the wireless network connectivity 114 of the firmware 104, such as within wireless network settings that also indicate how to connect to the network 103 using the wireless network hardware 102.

Upon connection with the server 242, the firmware 104 downloads (260) updated operating system wireless network connectivity information from the server 242. For instance, the firmware 104 may provide information indicating the type of wireless network hardware 102 in the computing device 100, as well as the type and version of the operating system 112 installed on the device 100. Based on this information, the server 242 can transmit updated operating system wireless network connectivity information that is particular to the wireless network hardware 102 and the operating system 112.

The updated operating system wireless network connectivity information can include an updated wireless network hardware driver for installation within the operating system 112 in lieu of the existing driver for the wireless network hardware 102 that is already installed. The updated operating system wireless network connectivity information can additionally or instead include updated wireless network settings for use by the wireless network hardware driver to connect to and communicate with or over the network 103 using the wireless network hardware 102. The updated operating system wireless network connectivity information can include other information as well.

Upon downloading the updated operating system wireless network connectivity information, the firmware 104 clears (262) the flag that has been set to indicate that the operating system wireless network connectivity 116 has failed. The firmware 104 may in one implementation proceed with causing restart (264) of the computing device 100 to ultimately result in booting or loading of the operating system 112. In another implementation, the firmware 104 may immediately proceed to boot (264) or load the operating system 112 without first restarting the computing device 100.

Next, in the process 270 of FIG. 2C, if the firmware 104 restarted the computing device 100, then at restart (272), the firmware 104 after being loaded proceeds with booting (274) or loading the operating system 112. In the case in which the firmware 104 did not restart the computing device 100, then the firmware 104 immediately proceeds with booting (274) or loading of the operating system 112. As before, the service 204 registers (276) with the operating system 112 once the operating system 112 has started to receive status change events regarding the wireless network connectivity 116.

The service 204 further detects that updated wireless network connectivity information has been downloaded (278). For example, when the firmware 104 retrieves the updated wireless network connectivity information from the server 242, it may store the updated information on the storage device, such as the hard disk drive or SSD, on which the operating system 112 is stored. The updated wireless network connectivity information may be stored in a predefined location. Therefore, the service 204 inspects this location at startup in order to detect that the updated wireless network connectivity information has been downloaded.

In response, the service 204 triggers (280) installation of the updated wireless network connectivity information at the operating system 112, which thus installs the updated information (282). More generally, the operating system 112 restores its wireless network connectivity 116 using the updated wireless network connectivity information. If the updated information includes an updated wireless network hardware driver, for instance, the operating system 112 may install the updated driver to replace the existing driver for the wireless network hardware 102. If the updated information includes updated wireless network settings, the (updated or existing) wireless network hardware driver may be reconfigured according to the updated information to use the updated network settings when connecting to and communicating with or over the network 103 via the wireless network hardware 102.

Therefore, the end result is that the operating system wireless network connectivity 116 can be restored by leveraging the firmware wireless network connectivity 114 that has not failed. Per the processes 210, 250, and 270, the service 204 at the operating system 112 informs the firmware 104 of the failure of the operating system wireless network connectivity 116 via the setting of a flag, so that upon restart the firmware 104 can retrieve and store updated wireless network connectivity information that the operating system 112 can use to restore the wireless network connectivity 116. An application 202 running in, on, or in conjunction with operating system 112 can then access (284) the wireless network 103.

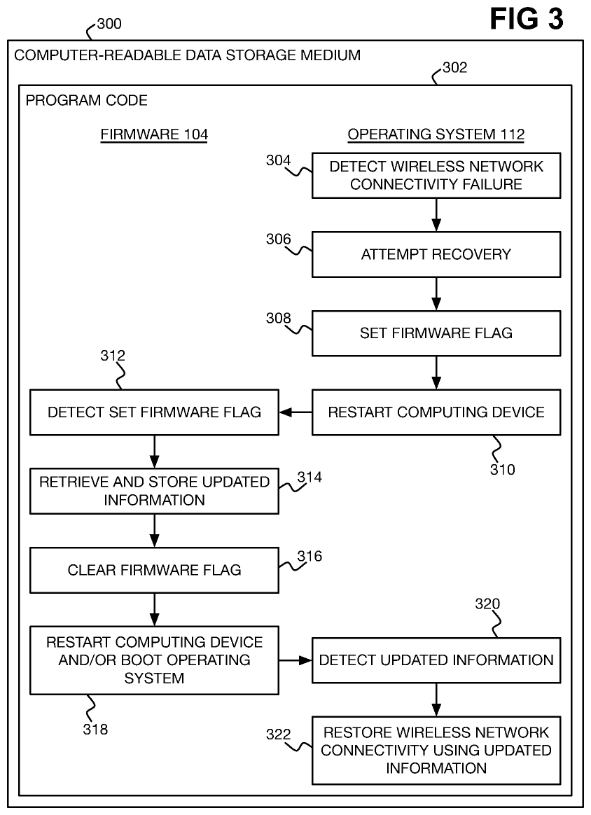

FIG. 3 shows an example non-transitory computer-readable data storage medium 300 storing program code 302 executable by the computing device 100 to perform processing that is consistent with but more general than the processes 210, 250, and 270. Different parts of the program code 302 are executable by the firmware 104 (e.g., by the embedded controller thereof), as well as by the processor 106 to run the operating system 112. Therefore, the program code 302 in the left column is said to be executed by the firmware 104, and this portion of the program code 302 may be part of the BIOS or UEFI that is executed by the embedded controller. The program code 302 in the right column is said be executed at the operating system 112, in that this portion of code is executed by the processor 106 when running the operating system 112, including the service 204 that registers with the operating system 112.

The processing includes detecting at the operating system 112 that the operating system wireless network connectivity 116 has failed (304). The processing can include, in response, attempting at the operating system 112 to recover the wireless network connectivity 116 (306). The processing includes, in response to recovery being unsuccessful, and thus after detecting that the wireless network connectivity 116 has failed, setting at a firmware flag indicating that the wireless network connectivity 116 has failed (308), and restarting the computing device 100 (310), at the operating system 112.

The processing includes, at restart of the computing device 100 (which may be considered a first restart of the device 100), the firmware 104 detecting that the firmware flag has been set (312). The processing includes, in response, the firmware 104 retrieving and storing updated operating system wireless network connectivity information using the firmware wireless network connectivity 114 (314), and then clearing the firmware flag (316). The processing includes the firmware 104 thereafter restarting the computing device 100 again (which may be considered a second restart of the device 100), and/or booting the operating system 112 (318).

At (second) restart of the computing device 100 and/or at boot of the operating system 112, the processing includes detecting the updated wireless network connectivity information at the operating system 112 (320). The processing includes, in response to detecting the updated wireless network connectivity information, restoring the operating system wireless network connectivity 116 at the operating system 112 using the updated information (322). Therefore, the operating system wireless network connectivity 116 is restored by leveraging the separate and independent firmware wireless network connectivity 114.

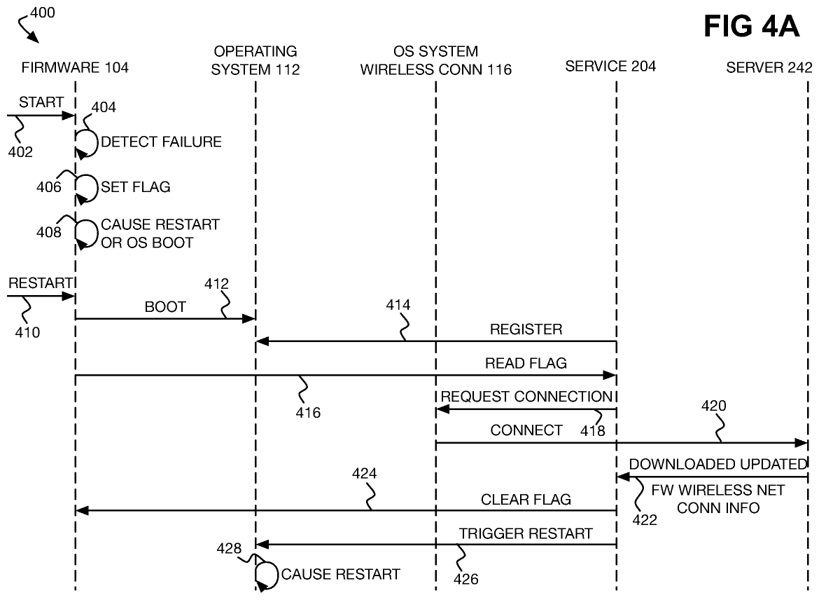

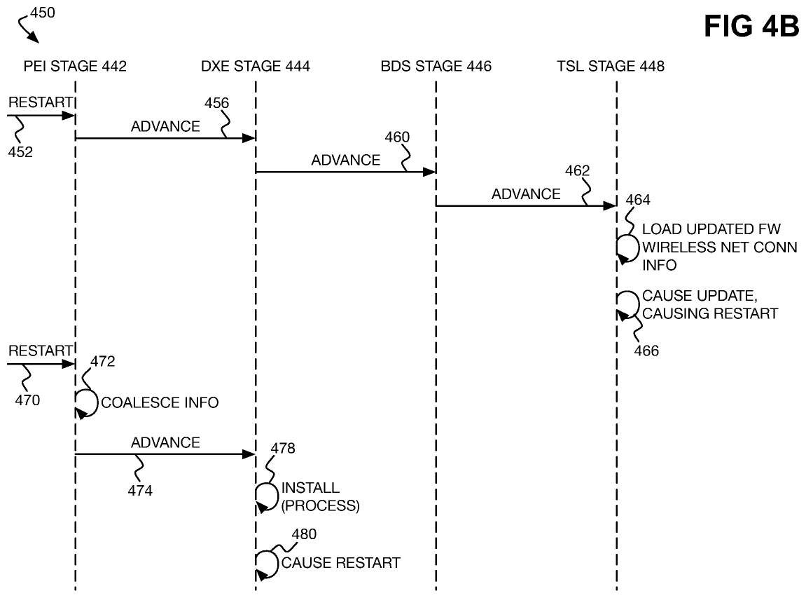

FIGS. 4A and 4B show respective processes 400 and 450 for restoring the firmware wireless network connectivity 114 upon failure by leveraging the operating system wireless network connectivity 116 that has not failed. In FIG. 4A, the firmware 104, the operating system 112, the operating system wireless connectivity 116, the service 204, and the server 242 are depicted. As before, the service 204 can be a background service that runs when the operating system 112 is running, and the server 242 may be a cloud server maintained by or for the manufacturer of the computing device 100, for instance. The service 204 and/or the server 242 may be the same service 204 and/or server 242 as in processes 210, 250, and 270, or a different service 204 and/or server 242. The firmware 104 may be or include the embedded controller, the BIOS, and/or the UEFI.

In the process 400 of FIG. 4A, at start (including restart) (402) of the computing device 100, the firmware 104 is initially loaded and detects that the firmware wireless network connectivity 114 has failed (404). For example, the firmware 104 may attempt to connect to the wireless network 103 and be unsuccessful, as a result of outdated program code for the wireless network hardware 102 (e.g., in effect or in actuality, an outdated firmware driver for the wireless network hardware 102), or as a result of outdated wireless network settings for the wireless network 103. As another example, the firmware 104 may be able to successfully connect to the wireless network 103, but be unable to reach the server 242, as a result of outdated wireless network settings specifying the server 242.

The firmware 104 in response sets (406) a flag in the firmware 104 indicating that the firmware wireless network connectivity 114 has failed. The flag that is set is a different flag than that set in the processes 210, 250, and 270. The embedded controller may set the flag within a corresponding register of the BIOS or UEFI that is non-volatile (and which may survive restart of the computing device 100). The firmware 104 then causes the computing device 100 to restart (408) to ultimately result in booting or loading of the operating system 112. In another implementation, the firmware 104 may immediately to boot (264) or load the operating system 112 without first restarting the computing device 100.

If the firmware 104 restarted the computing device 100, then at restart (410), the firmware 104 after being loaded proceeds with booting (412) or loading the operating system 112. In the case in which the firmware 104 did not restart the computing device 100, then the firmware 104 immediately proceeds with booting (412) or loading of the operating system 112. As before, the service 204 registers (414) with the operating system 112 once the operating system 112 has started. The service 204 reads (416) the flag from the firmware 104 indicating whether the firmware wireless network connectivity 114 has failed. The service 204 has information indicating which register this flag is stored in the firmware 104, for instance.

Therefore, the service 204 detects that the firmware wireless network connectivity 114 has failed by determining the read flag has been set. In response to detecting setting of the flag, the service 204 requests (418) via the operating system wireless network connectivity 116, connection (420) to the server 242 that is accessible over the network 103. The identification of the server 242 may be specified within the wireless network connectivity 116, such as within wireless network settings that also indicate how to connect to the network 103 using the wireless network hardware 102, or may be specified within the service 204 itself. The identification of the server 242 may have been updated at the operating system 112 (i.e., within the wireless network connectivity 116 or the service 204), but not at the firmware wireless network connectivity 114, for instance, which is why the firmware wireless network connectivity 114 may have failed.

Upon connection with the server 242, the service 204 downloads (422) updated firmware wireless network connectivity information from the server 242. For instance, the service 204 may provide information indicating the type of wireless network hardware 102 in the computing device 100, as well as the type and version of the firmware 104 of the device 100. Based on this information, the server 242 can transmit updated firmware wireless network connectivity information that is particular to the wireless network hardware 102 and the firmware 104.

The updated firmware system wireless network connectivity information can include firmware program code to realize the wireless network connectivity 114 (i.e., in effect or in actuality, an updated firmware wireless network hardware driver) for overwriting existing such firmware program code. The updated operating system wireless network connectivity information can additionally or instead include updated wireless network settings for use by the firmware wireless network connectivity 114 to connect to and communicate with or over the network 103 using the wireless network hardware 102. The updated firmware wireless network connectivity information can include other information as well. For instance, the updated information can include updated information as to the identification of the server 242 once connection has been made to the network 103.

Upon downloading the updated firmware wireless network connectivity information, the service 204 clears (424) the flag that has been set to indicate that the firmware system wireless network connectivity 114 has failed. The service 204 then triggers restart (426) of the computing device 100 with the operating system 112. The operating system 112 responsively causes (428) the computing device 100 to restart, which may be considered a first restart of the device 100. The user may first be notified and his or her approval requested before the operating system 112 causes such restart, and the user may also be notified that the firmware wireless network connectivity 114 has failed and its restoration will be attempted upon restart of the computing device 100.

Next, in FIG. 4B, the process 450 pertains to the firmware 104 including UEFI. Four execution stages, or phases, of UEFI are particularly depicted in FIG. 4B: a pre-EFI initialization (PEI) stage 442; a driver execution environment (DXE) stage 444; a boot device selection (BDS) stage 446; and a transient system load (TSL) stage 448. Other UEFI stages or phases can include a security (SEC) stage that occurs before the PEI stage 442, and runtime (RT) and after life (AL) stages that occur after the TSL stage 448.

In general, the SEC stage serves as the root of trust within the UEFI of the firmware 104 of the computing device 100. At the PEI stage 442, the UEFI operates in a nascent stage, using just on-processor resources to, for instance, describe memory in hand-off blocks (HOBs), which are position-independent data structures, and describe firmware volume locations in the HOBs. At the DXE stage 444, an execution environment is initialized, including a DXE foundation and dispatcher as well as DXE drivers.

Also in general, at the BDS stage 446, a portion of a BDS architectural protocol is performed to initialize console devices, load device drivers (including that for the wireless network hardware 102), and attempt to load and execute boot sections. At the TSL stage 448, the boot loader for the operating system 112 is loaded. Portions of the firmware 104 that are to remain persistent are provided at the RT stage, whereas other portions are shutdown at the AL stage after maintaining their state.

Therefore, in the process 450, restart (452) of the computing device 100 as caused by the operating system 112 at the end of the process 400 results in advancement to the PEI stage 442 (such as from the SEC stage), and then to the DXE stage 444 (456), followed by to the BDS stage 446 (460) and then to the TSL stage 448 (462). In the process 450, the updated firmware wireless network connectivity information retrieved and stored by the service 204 is loaded at the TSL stage 448 (464), such as during the final boot loader.

The loading of the updated firmware wireless network connectivity information may occur as part of UEFI capsule processing. The wireless network connectivity information may be stored as or in a UEFI capsule. When the service 204 retrieves this UEFI capsule from the server 242 in the process 400, the service 204 stores the capsule on a storage device at a predefined location at which the last boot loader is stored or that is inspected by the last boot loader. Upon loading the UEFI capsule, an update capsule function is then called at the TSL stage 448, which causes (466) another restart of the computing device 100 to ultimately update the firmware wireless network connectivity 114 using the updated firmware wireless network connectivity information (i.e., the EEFI capsule). This restart may be considered a second restart of the device 100.

At the resulting restart (470) of the computing device 100, during the PEI stage 442 the updated firmware wireless network connectivity information (i.e., the UEFI capsule) is coalesced (472). Coalescing the UEFI capsule means that the capsule is returned to a form in which the capsule can be installed in the firmware 104. That is, coalescing the updated firmware wireless network connectivity information permits the updated information to overwrite and thus update and restore the firmware wireless network connectivity 114 that has failed. Prior to coalescing, the UEFI capsule is not in a state in which it can be processed to update the firmware 104 and thus the wireless network connectivity 114 of the firmware 104.

After the updated firmware wireless network connectivity information has been coalesced, the PEI stage 442 advances (474) to the DXE stage 444, at which the UEFI capsule is processed (478) to install the updated firmware program code within the updated firmware wireless network connectivity information. Processing the UEFI capsule results in restoration of the firmware wireless network connectivity 114 by installing updated firmware program code that provides for usage of the wireless network connectivity 114 to connect to the network 103 using the wireless network hardware 102. Processing the UEFI capsule can include authenticating the capsule, setting a firmware image contained in the payload of the capsule in the firmware 104, updating the firmware code per the image, and then publishing an update to the GUID partition table.

Once the UEFI capsule has been processed, the firmware wireless network connectivity 114 has been restored. The end result is therefore that the wireless network connectivity 114 has been restored by leveraging the operating system wireless network connectivity 116. Per the process 400, the firmware 104 informs the service 204 running at the operating system 112 that the firmware wireless network connectivity 114 has failed via the setting of a flag, so that the service 204 retrieves and stores updated firmware wireless network connectivity information that the firmware 104 uses to restore the wireless network connectivity 114. For the firmware 104 to utilize the restored firmware wireless network connectivity 114, the DXE stage 444 causes (480) the computing device 100 to restart.

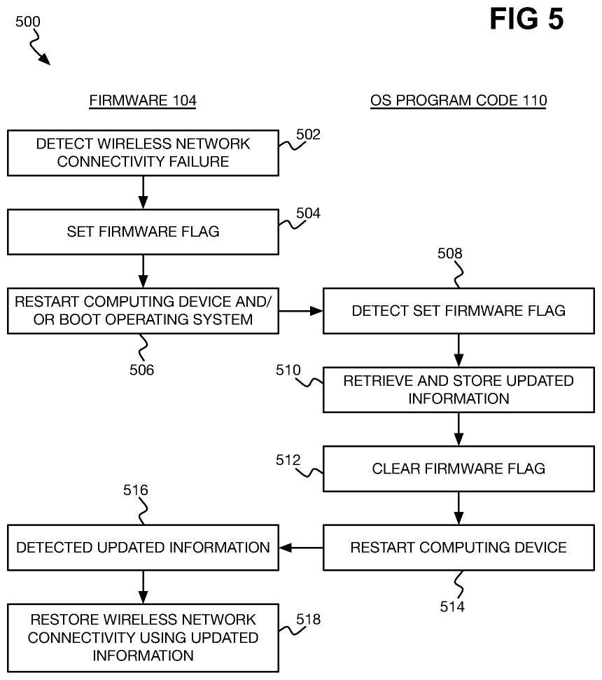

FIG. 5 shows an example method 500 that is consistent with but more general than the processes 400 and 450. The method 500 may be realized as program code stored on a non-transitory computer-readable data storage medium and executable by the computing device 100. The parts of the method 500 in the left column are performed by the firmware 104. The parts of the method 500 in the right column are performed by the program code 110 that is executed to run the operating system 112, including the service 204 and the wireless network hardware driver of the operating system wireless network connectivity 116. The parts of the method 500 in the right column can be considered as being performed at the operating system 112, with the operating system program code 110 including that for the service 204.

The method 500 includes detecting by the firmware 104 that the firmware wireless network connectivity 114 has failed (502). The method 500 can include, in response, setting at a firmware flag by the firmware 104 which indicates that the wireless network connectivity 114 has failed (504). The method 500 includes the firmware 104 then restarting the computing device 100 and/or booting the operating system 112 (506).

The method 500 includes, at restart of the computing device 100 (which may be considered a first restart of the device 100) and/or at booting of the operating system 112, detecting at the operating system 112 that the firmware flag has been set (508). The method 500 includes, in response, retrieving and storing at the operating system 112 updated firmware wireless network connectivity information using the operating system wireless network connectivity 116 (510), and then clearing the firmware flag (512). The processing includes thereafter restarting, at the operating system 112, the computing device 100 (which may be considered a second restart of the device 100 if the device 100 was previously restarted) (514).

At this restart of the computing device 100, the method includes the firmware 104 detecting the updated wireless network connectivity information (516). The processing includes, in response to detecting the updated wireless network connectivity information, restoring the firmware wireless network connectivity 114 at the firmware 104 using the updated information (518). Therefore, the firmware wireless network connectivity 114 is restored by leveraging the separate and independent operating system wireless network connectivity 116.

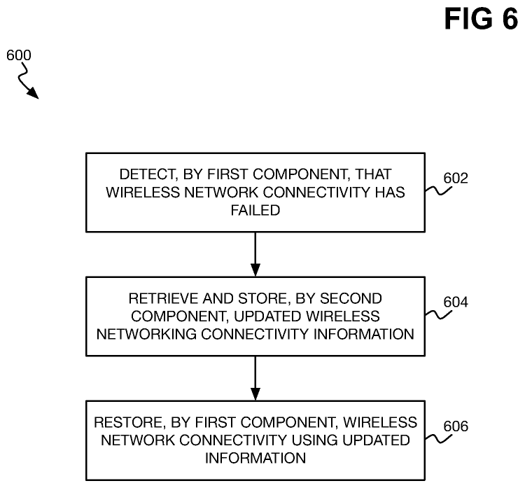

FIG. 6 shows another example method 600 that is consistent with but more general than the method 500 and the process performed by the program code 302. The method 600 includes detecting, by a first component of the computing device 100, that first component wireless network connectivity has failed (602). The method includes subsequently retrieving and storing, by a second component of the computing device 100 using second component wireless network connectivity, updated first component wireless network connectivity information (604). The method includes restoring, by the first component, the first component wireless network connectivity using the updated first component wireless network connectivity information retrieved and stored by the second component (606).

Either the first component is the operating system 112 and the second component is the firmware 104, or the first component is the firmware 104 and the second component is the operating system 112. In the case of the program code 302, the operating system 112 is the first component and the firmware 104 is the second component, such that the first and second wireless network connectivity are the wireless network connectivity 116 and 114, respectively. In the case of the method 500, the firmware 104 is the first component and the operating system 112 is the second component, such that the first and second wireless network connectivity are the wireless connectivity 114 and 116, respectively.

Techniques have been described herein for restoring wireless network connectivity of a computing device 100 upon failure using other wireless network connectivity of the computing device 100 that has not failed. When the wireless network connectivity 116 of the operating system 112 has failed, the wireless network connectivity 114 of the firmware 104 can be leveraged to retrieve uploaded wireless network connectivity information to restore the operating system wireless network connectivity 116. Similarly, when the wireless network connectivity 114 of the firmware 104 has failed, the wireless network connectivity 116 of the operating system 112 can be leveraged to retrieve uploaded wireless network connectivity information to restore the firmware wireless network connectivity 114.

We claim:

1. A non-transitory computer-readable data storage medium storing program code executable by a computing device having an operating system and firmware to perform processing comprising:
setting, at the operating system, a firmware flag indicating that operating system wireless network connectivity has failed, and then restarting the computing device;
after restart, and in response to detecting that the firmware flag has been set, retrieving and storing, by the firmware, updated operating system wireless network connectivity information using firmware wireless network connectivity; and
restoring, at the operating system, the operating system wireless network connectivity using the updated operating system wireless network connectivity information.

2. The non-transitory computer-readable data storage medium of claim 1, wherein the updated operating system wireless network connectivity information comprises an updated operating system wireless network driver,
and wherein restoring the operating system wireless network connectivity comprises installing the updated operating system wireless network driver.

3. The non-transitory computer-readable data storage medium of claim 1, wherein the updated operating system wireless network connectivity information comprises updated operating system wireless network settings,
and wherein restoring the operating system wireless network connectivity comprises perform reconfiguration according to the updated operating system wireless network settings.

4. The non-transitory computer-readable data storage medium of claim 1, wherein the firmware wireless network connectivity uses a different wireless network driver and different wireless network settings that the operating system wireless network connectivity.

5. The non-transitory computer-readable data storage medium of claim 1, wherein the processing further comprises:
detecting, at the operating system, that the operating system wireless network connectivity has failed, such that the firmware flag is set after detecting that the operating system wireless network connectivity has failed.

6. The non-transitory computer-readable data storage medium of claim 5, wherein the processing further comprises:
in response to detecting that the operating system wireless network connectivity has failed, attempting, at the operating system, to recover the operating system wireless network connectivity,
wherein the firmware flag is set and the computing device is then restarted when attempting to recover the operating system wireless network connectivity is unsuccessful.

7. The non-transitory computer-readable data storage medium of claim 1, wherein the processing further comprises:
after storing the updated operating system wireless network connectivity information, clearing the firmware flag and restarting the computing device again, by the firmware.

8. The non-transitory computer-readable data storage medium of claim 1, wherein the processing further comprises:
detecting, at the operating system, the updated operating system wireless network connectivity information,
wherein the operating system wireless network connectivity is restored in response to detecting the updated operating system wireless network connectivity information.

9. A computing device comprising:
firmware to:
set a firmware flag indicating that firmware wireless network connectivity has failed; and
after restart of the computing device, restore the firmware wireless network connectivity using updated firmware wireless network connectivity information;
a processor; and
a memory storing operating system program code to:
in response to detecting that the firmware flag has been set, retrieve and store the updated wireless network connectivity information using operating system wireless network connectivity, and restart the computing device.

10. The computing device of claim 9, wherein the firmware uses the updated firmware wireless network connectivity information retrieved and stored by the operating system program code to restore the firmware wireless network connectivity.

11. The computing device of claim 9, wherein the firmware is further to:
detect that the firmware wireless network connectivity has failed,
wherein the firmware flag is set in response to detecting that the firmware wireless network connectivity has failed.

12. The computing device of claim 9, wherein the firmware is further to:
detect the updated firmware wireless network connectivity information,
wherein the firmware wireless network connectivity is restored in response to detecting the updated firmware wireless network connectivity information.

13. A method comprising:
detecting, by a first component of a computing device, that first component wireless network connectivity has failed;
subsequently retrieving and storing, by a second component of the computing device using second component wireless network connectivity, updated first component wireless network connectivity information; and
restoring, by the first component, the first component wireless network connectivity using the updated first component wireless network connectivity information retrieved and stored by the second component,
wherein either the first component is an operating system and the second component is firmware, or the first component is the firmware and the second component is the operating system.

14. The method of claim 13, wherein the first component is the operating system and the second component is the firmware.

15. The method of claim 13, wherein the first component is the firmware and the second component is the operating system.
